(19) United States
(12) Patent Application Publication
(10) Pub. No.: US 2014/0048154 A1
(43) Pub. Date: Feb. 20, 2014

(54) SUBSTANTIALLY CONCEALED IRRIGATION SYSTEM

(71) Applicant: Melvin Scott McCombs, Henderson, NV (US)

(72) Inventor: Melvin Scott McCombs, Henderson, NV (US)

(21) Appl. No.: 13/593,304

(22) Filed: Aug. 23, 2012

Related U.S. Application Data
(63) Continuation-in-part of application No. 13/588,802, filed on Aug. 17, 2012.

(51) Int. Cl. F16L 3/00

(52) U.S. Cl. 137/343

(57) ABSTRACT

A water device comprising at least a water-carrying vessel and head, and a structure configured to blend in with a landscape environment wherein the structure conceals at least a portion of the water-carrying vessel while leaving the head exposed. Depending on the configuration, the structure may resemble a rock, bark, plant trunk, stone, bedding material, pavers, edge brick and similar decorative landscaping items and may be fabricated of resins, cements, epoxies, fillers, polymers, metals, recycled materials. Natural articles like stone and bark may also be used. Illumination systems, speakers and self-contained music systems may be included as well. Power may be provided by batteries, electricity or solar panels.

### CROSS-REFERENCE

This application is a continuation-in-part of U.S. application Ser. No. 13/588,802 filed Aug. 17, 2012 which is incorporated herein by reference for all purposes.

### FIELD OF THE INVENTION

The embodiments of the present invention relate to an irrigation system which can be concealed in the surrounding environment.

### BACKGROUND

Irrigation systems for residential and commercial properties are ubiquitous throughout the U.S. and many foreign jurisdictions. Such irrigation systems may include sprinklers, bubblers, drips and the like. While such irrigation systems are suitable for their intended purposes, they are often unsightly, broken and not directing water to the plant.

Thus, there exists a need for irrigation systems which are substantially concealable in their environmental surroundings, protected from breakage and directed to the subject plant.

### SUMMARY

Accordingly, a first embodiment of the present invention comprises a water device comprising at least a water-carrying vessel and head; and a structure configured to blend in with a landscape environment, said structure concealing at least a portion of said water-carrying vessel while leaving said head exposed. Depending on the embodiment, the structure may resemble a rock, bark, plant trunk, stone, bedding material and similar decorative landscaping items and may be fabricated of resin, stones, cements and fillers. Natural stone and bark may also be used.

In one embodiment, an irrigation device is fabricated by molding a structure around a portion of the water-carrying vessel. Alternatively, the structure may be formed with a channel configured to receive a portion of the water-carrying vessel.

Another embodiment of the present invention is a method comprising: molding a structure around a portion of a water-carrying vessel of a water device while leaving a water device head exposed, said structure configured to blend in with a landscape environment. Another embodiment of the present invention is a method comprising: molding a structure with a channel therethrough, said structure configured to blend in with a landscape environment; and inserting a water-carrying vessel of a water device in said channel while leaving a water device head exposed.

Another embodiment of the present invention includes an illumination system and/or speaker and/or audio system. These features allow the water device to illuminate adjacent natural landscape (e.g., tree) and man-made articles (e.g., plant trestle) and disburse audio tones such as music.

Other variations, embodiments and features of the present invention will become evident from the following detailed description, drawings and claims.

### BRIEF DESCRIPTION OF THE DRAWINGS

FIGS. 1a and 1b illustrate perspective views of bubblers of the type which may be used with the embodiments of the present invention;

FIG. 2 illustrates a block diagram of a conventional irrigation system of the type which may be used with the embodiments of the present invention;

FIG. 3a-3c illustrate bubblers according to the embodiments of the present invention;

FIGS. 4a and 4b illustrate a prior art bubbler installed in comparison to a bubbler installed according to the embodiments of the present invention;

FIG. 5 illustrates a first method of fabricating an irrigation device according to the embodiments of the embodiments of the present invention;

FIG. 6 illustrates a second method of fabricating an irrigation device according to the embodiments of the present invention;

FIG. 7 illustrates a third method of fabricating an irrigation device according to the embodiments of the present invention;

FIG. 8 illustrates an alternative bubbler including an illumination system according to the embodiments of the present invention;

FIG. 9 illustrates another alternative bubbler including an illumination system and speaker according to the embodiments of the present invention;

FIG. 10 illustrates another alternative bubbler including a self-contained audio system according to the embodiments of the present invention; and

FIG. 11 illustrates an alternative bubbler including an illumination system and solar panel according to the embodiments of the present invention.

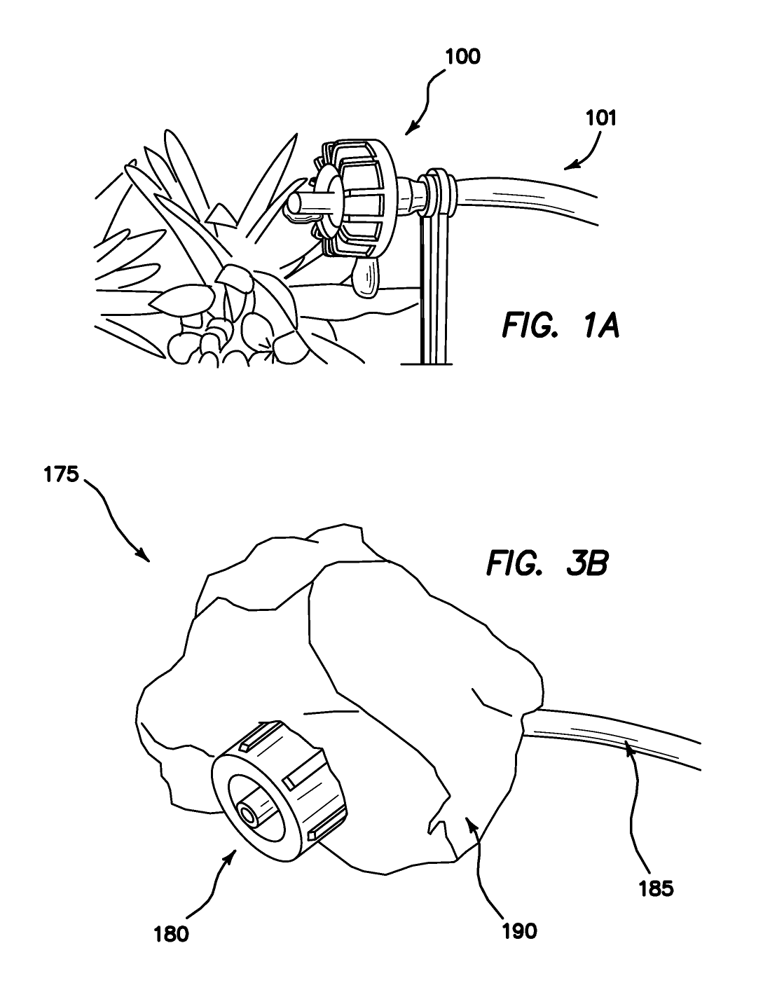

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

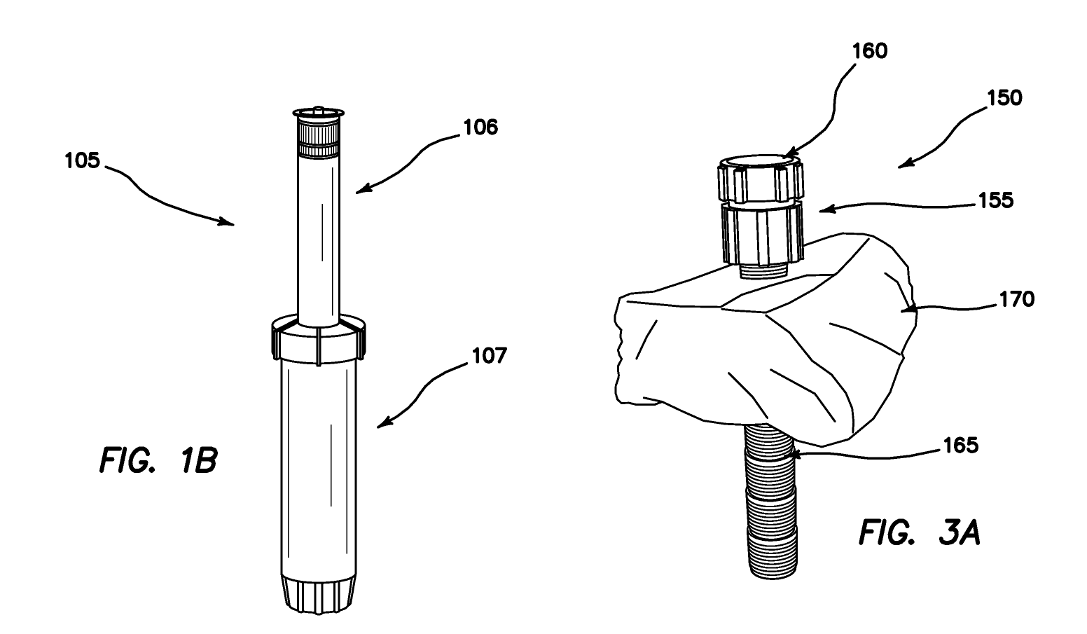

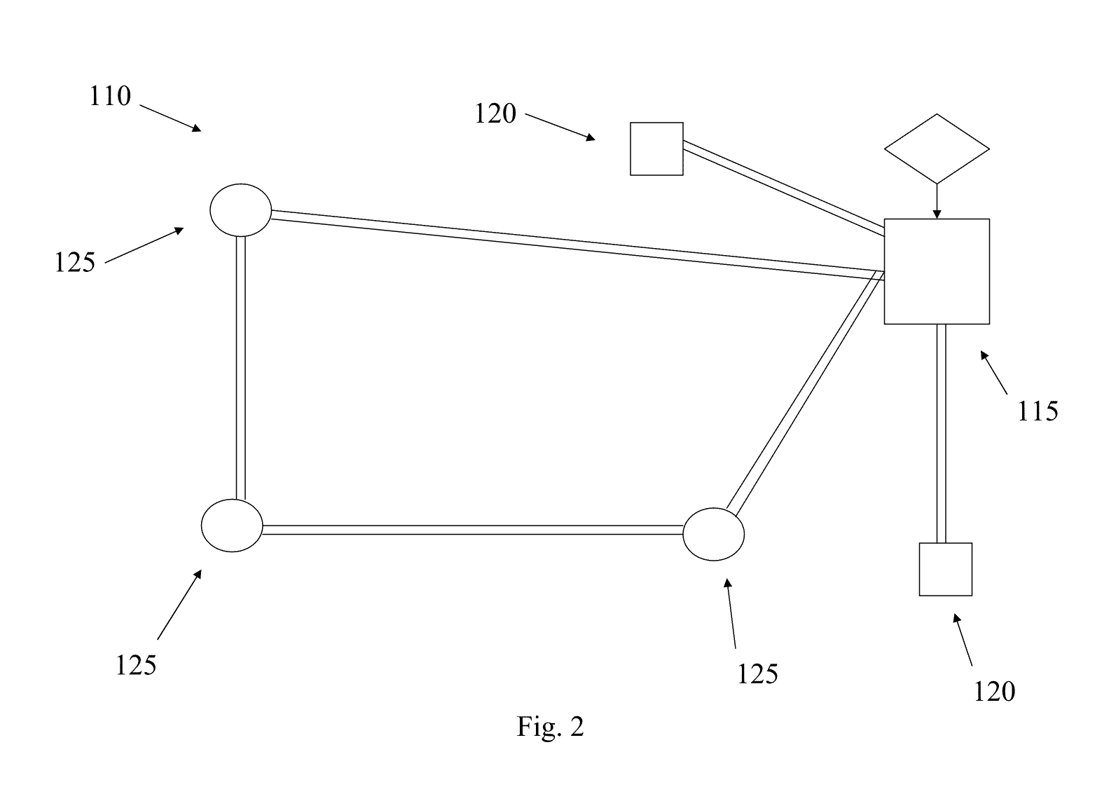

Initial reference is made to Figs. la and lb illustrating perspective views of a prior art bubbler 100 and pop-up sprinkler 105 of the type suitable for use with the embodiments of the present invention. Bubblers 100 are normally installed, along with flexible tubing 101, proximate to a plant or arrangement of plants and operate to dispense drops of water to keep the plant or plants hydrated. Pop-up sprinklers 105 are normally installed around edges of grass areas and aimed to pop-up and water the grass. When activated, a sprinkler mechanism 106 pops-up from a housing 107 and begins dispensing water. As shown in FIG. 2, a conventional irrigation system 110 comprises a water source 115 connected to bubblers 120, sprinklers 125 and the like, and a timer 130 which controls activation and de-activation of the irrigation system 110. Water flow control means may also be linked to the irrigation system 110. Tubing, piping, conduits and similar water-carrying vessels 135 link the water source to the bubblers 120 and sprinklers 125.

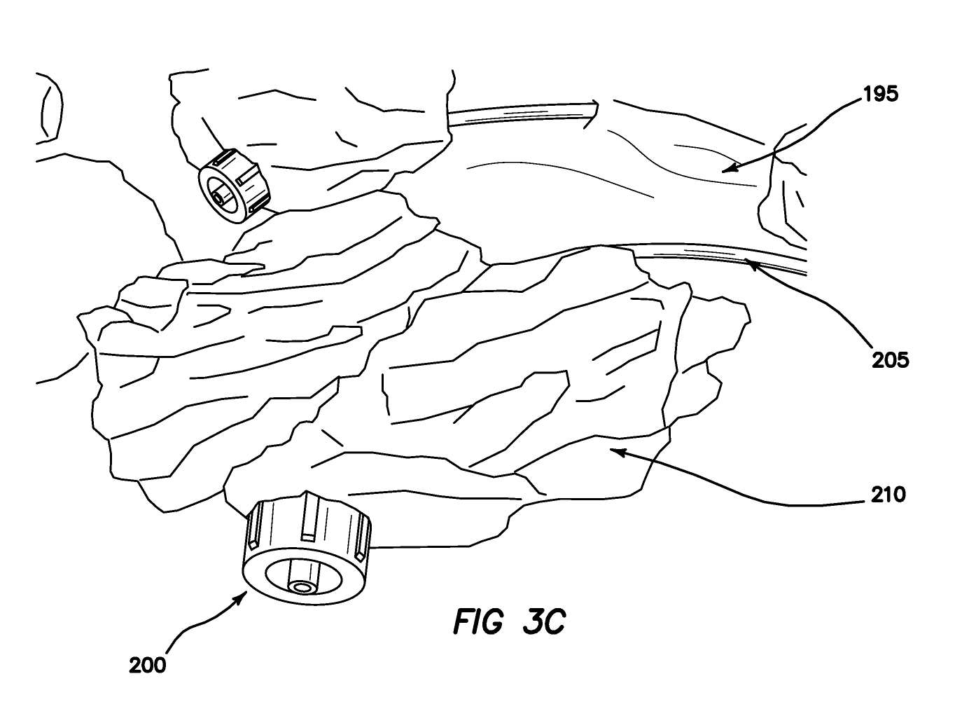

FIG. 3a shows a sprinkler 150 having a head 155, cap 160 and body 165 with a channel (i.e., water-carrying vessel) therethrough for carrying water to the head 155. A structure 170 in the form of a stone surrounds a portion of the body 165 and water-carrying channel therethrough. FIG. 3b shows a bubbler 175 having a head 180 and flexible tubing 185 for carrying water to the head 180. A structure 190 in the form of a stone surrounds a portion of the tubing 185. FIG. 3c shows a bubbler 195 having a head 200 and tubing 205 for carrying water to the head 195. A structure 210 in the form of bark surrounds a portion of the tubing 205. Other structures include brick pavers, edge bricks and similar structures. Alternatively, structures may be molded into decorative shapes such as animals, plants and similar shapes suitable for the environmental area in which the structure is to be placed. As shown in FIGS. 3a-3c, the structures 170, 190 and 210 are positioned proximate the heads 155, 180 and 195 and surround the water-carrying vessel of the bubbler or sprinkler By positioning the structures 170, 190 and 210 proximate the heads 155, 180 and 195 allows the devices to be substantially concealed in the landscape environment because the piping or tubing carrying water to the head 155, 180 and 195 is concealed by the structures 170, 190 and 210. Those skilled in the art will recognize that the structures 170, 190 and 210 may be positioned elsewhere as well.

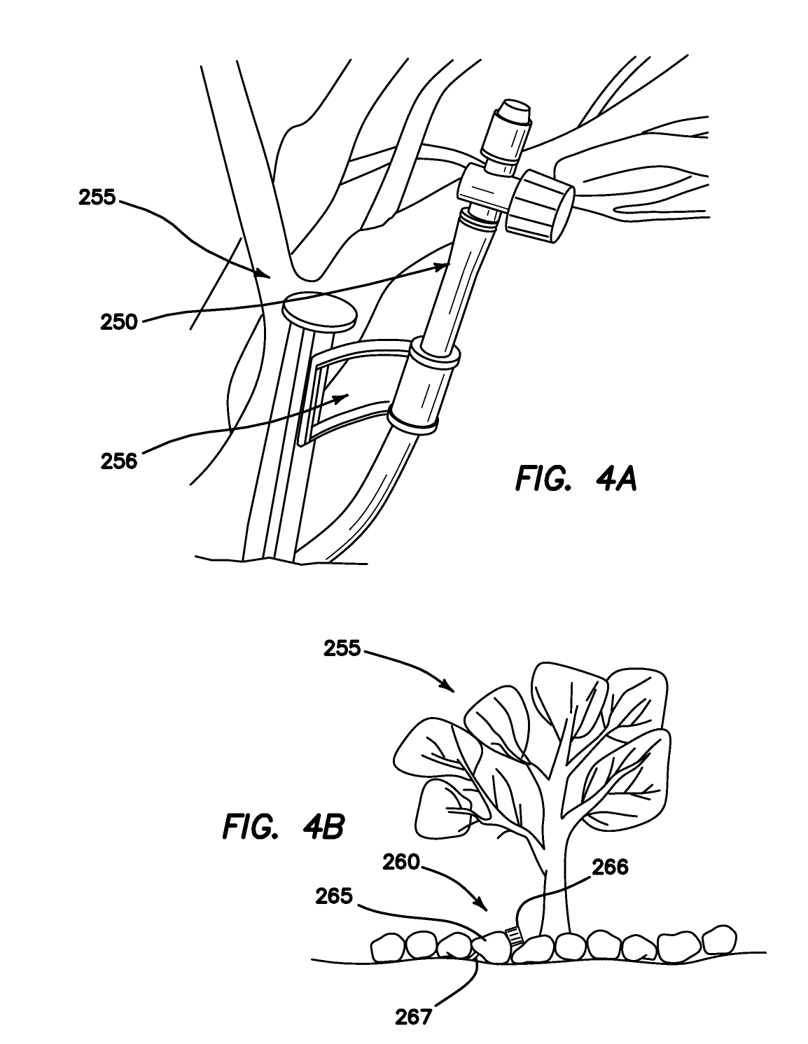

FIG. 4a shows a prior art bubbler 250 installed proximate a plant 255 using a spike 256 and FIG. 4b shows a bubbler 260 having a stone structure 265, head 266 and flexible tubing 267 installed proximate a plant. The stone structure 265 allows the bubbler 260 to blend in with the stones proximate the plant 255. The stone structure 265 also serves to protect the bubbler head 270 and maintain the direction of drip from the bubbler. That is, stone structure 265 acts to maintain a position of the bubbler 260 against the impact of the environment such as the rain and wind and other forces.

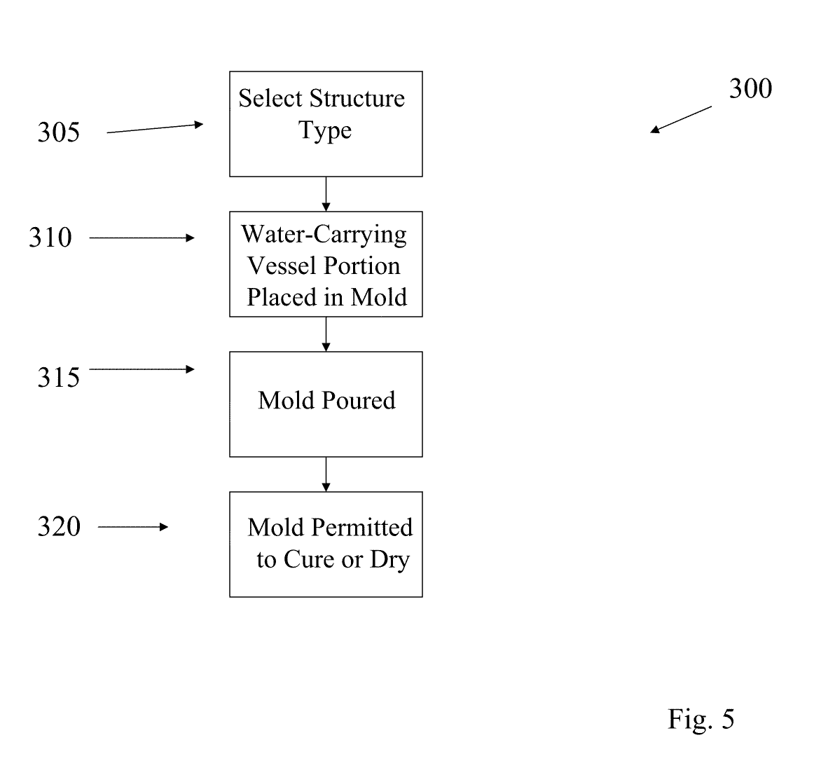

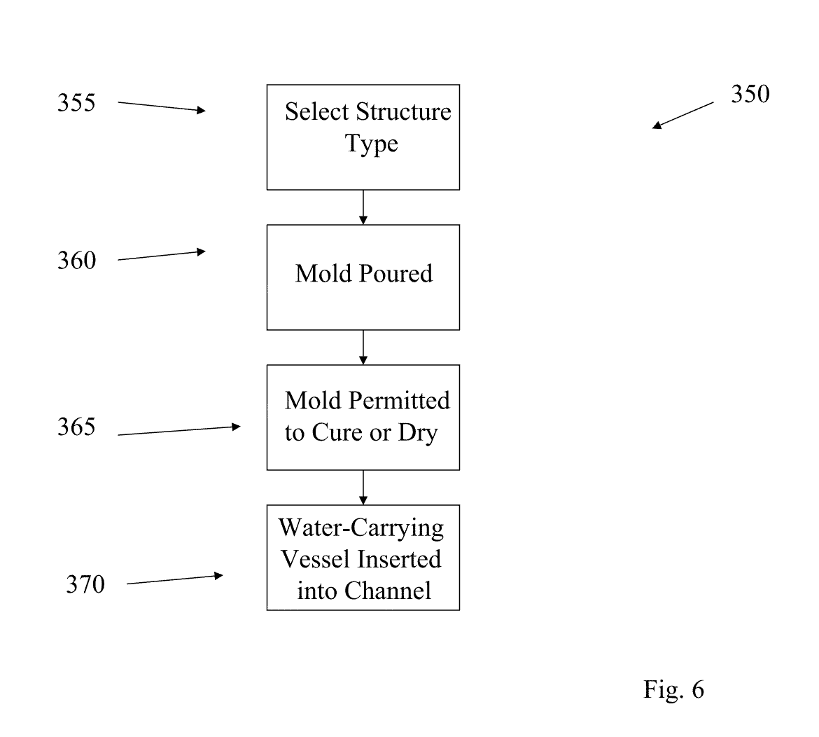

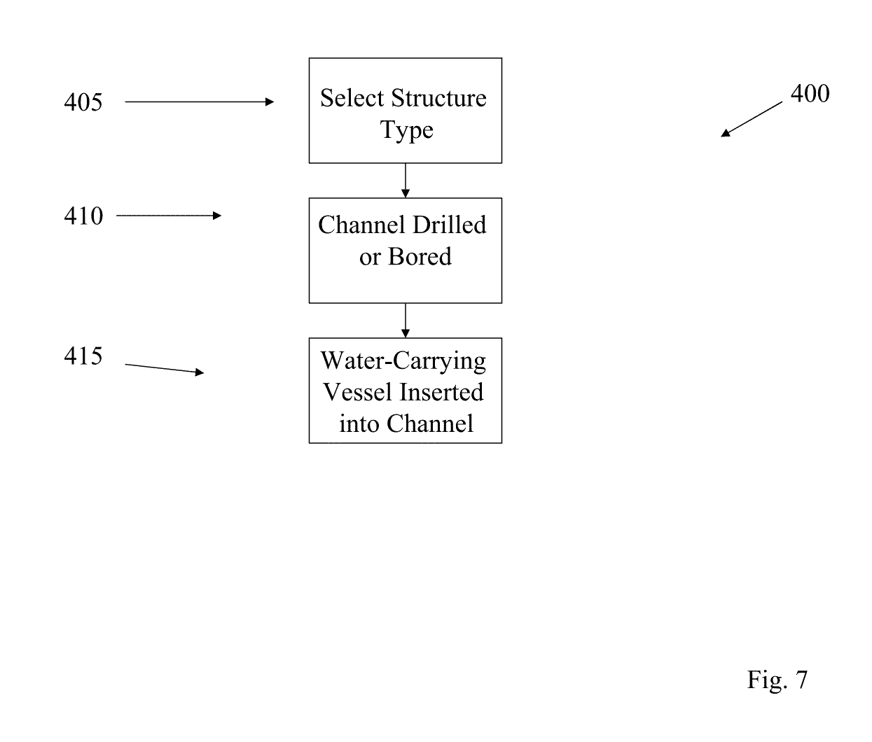

Fabricating the devices according to the embodiments of the present invention may take various forms as described relative to FIGS. 5, 6 and 7. A first fabrication method detailed in flow chart 300 of FIG. 5, involves a method of forming the structure around the water-carrying vessel (e.g., flexible tubing, piping, etc.). At 305, a structure type (e.g., stone, bark, etc.) is selected. At 310, the water-carrying portion of a water device is appropriately positioned in a structure mold. At 315, resins, cements, epoxies, fillers, polymers, metals, recycled materials (of the type disclosed in U.S. Pat. No. 8,092,593) and similar types of materials are poured into the mold to create the selected structure type. At 320, the molded structure is permitted to cure or dry with the water device molded therein forming a single unit. A second fabrication method detailed in flow chart 350 of FIG. 6. involves a method of forming the structure separately from the water device. At 355, a structure type (e.g., stone, bark, etc.) is selected. At 360, resins, cements, epoxies, fillers, polymers, metals, recycled materials and similar types of materials are poured into a mold having a channel therethrough to create the selected structure type. The channel dimensioned based on the water-carrying vessel to which is will be combined. At 365, the molded structure is permitted to cure or dry. At 370, the water-carrying vessel of the water device is inserted into the channel in the structure. The water-carrying vessel may be held in place within the structure channel via friction or a water proof adhesive. An alternative method is described in flow chart 400 of FIG. 7. At 405, the structure in the form of a natural stone or bark (or other article) is selected. At 410, a channel is drilled, bored or otherwise created in the structure. The channel dimensioned based on the water-carrying vessel to which is will be combined. At 415, a water-carrying vessel of a subject water device is inserted into the channel. The water-carrying vessel may be held in place within the structure channel via friction or a water proof adhesive.

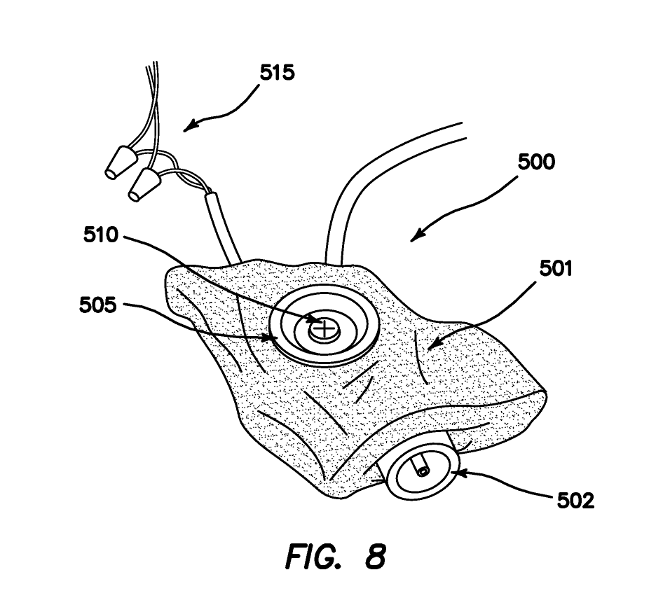

FIG. 8 shows a bubbler 500 including a stone structure 501 incorporating a water bubbler head 502 and an illumination system comprising a waterproof housing 505, light 510 (or one or more LEDs) and power cables 515. Optionally, a control circuit board may be incorporated within the housing 510 to provide lighting control beyond on-off functionality. The stone structure 501 may also integrate a battery compartment to provide battery power rather than electrical power transmitted via said power cables 515. Like the integration of the bubbler 500 within the stone structure 501, the housing 510 may be received by a cavity made in said stone structure 501 or the stone structure 501, if man-made, may be molded or otherwise formed around the housing 510. Similarly, the power cables 515 may run through drilled channels or the stone structure 501 be molded or otherwise formed around the power cables 515. The light 510 (or one or more LEDs) may be directed at a tree, bush or other article such that the article is illuminated.

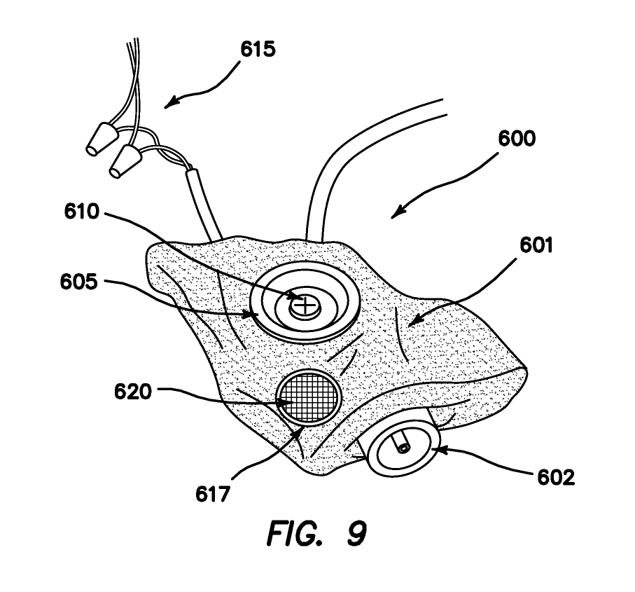

FIG. 9 shows a bubbler 600 with a stone structure 601 incorporating a bubbler head 602 and illumination system comprising a housing 605, light 610 and power cables 615. In addition, the stone structure 601 integrates a water proof housing 617, one or more speakers 620 and power cables (not shown). Alternatively, batteries may be received by a battery compartment. The speaker 620 may be provided with audio signals via a wired or wireless arrangement. If wired, audio wires may run from an audio source to said one or more speakers 620 along designated channels, or via channels through which said power cables 625 run. If wireless, audio signal may be transmitted by a transmitter to a receiver in communication with said one or more speakers 620. In one embodiment, the receiver is integrated into the stone structure 601 and the transmitter is in communication with an audio source such as a stereo system, television, computer, smart phone, tablet, MP3 player or any other device capable of generating audio signals.

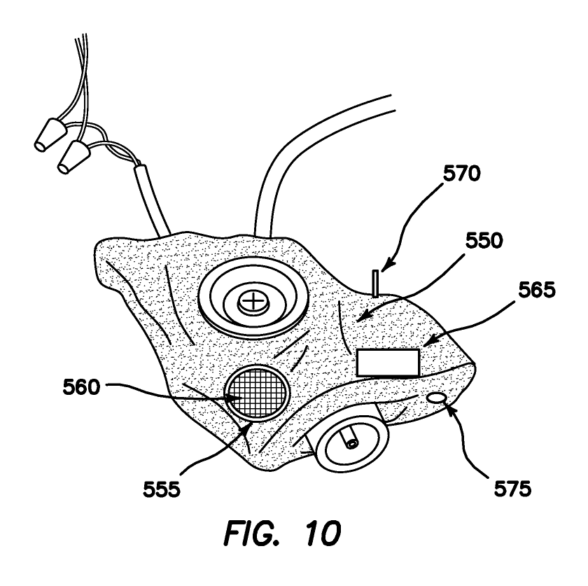

While FIG. 9 shows a speaker 520 integrated into the stone structure 601, in another embodiment, shown in FIG. 10, a stone structure 550 incorporates a self-contained music system comprising a waterproof housing 555, one or more speakers 560, interface 565, antenna 570 and port 575 for connection with an external music source such as a stereo system, television, computer, smart phone, tablet, MP3 player or any other device capable of generating audio signals. Electronics associated with the interface 565 and operation of the self-contained music system are incorporated within a waterproof cavity in the stone structure 601 or the stone structure 601 is molded around an electronics housing.

In another embodiment, the stone structure incorporates a bubbler and speaker only (i.e., no illumination system).

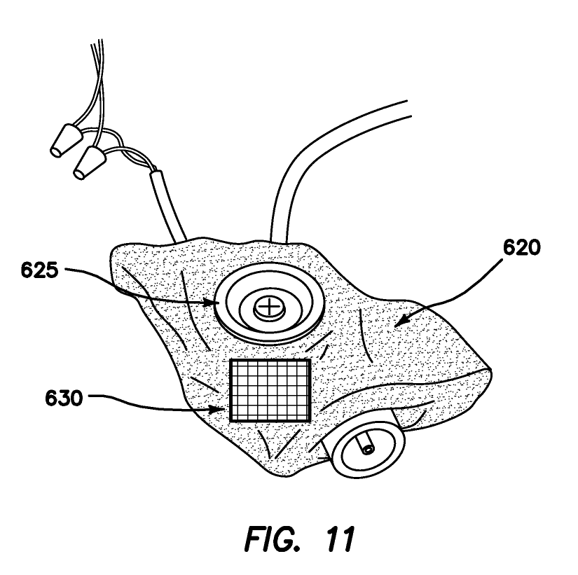

The embodiments of the present invention may be used with static sprinklers, pop-up sprinklers, drips, drip lines, bubblers and similar water devices. While batteries and electrical power are detailed above, another embodiment utilizes solar power facilitated by one or more solar panels integrated with the structure. FIG. 11 shows a stone structure 620 with an illumination system 625 and a solar panel for driving the same. The solar panel 625 is conventional and converts sun energy into electrical power.

Although the invention has been described in detail with reference to several embodiments, additional variations and modifications exist within the scope and spirit of the invention as described and defined in the following claims.

I claim:

1. An apparatus comprising:
a water device comprising at least a water-carrying vessel and head in communication with a water source;
a structure including a passageway receiving at least a portion of said water-carrying vessel while leaving said head exposed, said structure configured to blend in with a landscape environment; and
an illumination system incorporated in said structure, said illumination system including at least a waterproof housing, one or more light sources and means for providing power.

2. The apparatus of claim 1 wherein said water device is selected from the group consisting of a sprinkler, drip and bubbler.

3. The apparatus of claim 1 wherein said structure is fabricated with the appearance of stone.

4. The apparatus of claim 1 wherein said structure is fabricated with the appearance of bark.

5. The apparatus of claim 1 wherein said water-carrying vessel is flexible tubing.

6. The apparatus of claim 1 wherein said water-carrying vessel is piping.

7. The apparatus of claim 1 wherein said structure is natural stone.

8. The apparatus of claim 1 wherein said structure is natural bark.

9. The apparatus of claim 1 further comprising one or more solar panels.

10. An apparatus comprising:
a water device comprising at least a water-carrying vessel and head in communication with a water source;
a structure including a passageway receiving at least a portion of said water-carrying vessel while leaving said head exposed, said structure configured to blend in with a landscape environment; and
one or more speakers incorporated in said structure within a waterproof housing;
means for providing power to said speakers; and
means for transmitting audio signals to said one or more speakers.

11. The apparatus of claim 10 wherein said water device is selected from the group consisting of a sprinkler, drip and bubbler.

12. The apparatus of claim 10 wherein said structure is fabricated with the appearance of stone.

13. The apparatus of claim 10 wherein said structure is fabricated with the appearance of bark.

14. The apparatus of claim 10 wherein said water-carrying vessel is flexible tubing.

15. The apparatus of claim 10 wherein said water-carrying vessel is piping.

16. The apparatus of claim 10 wherein said structure is natural stone.

17. The apparatus of claim 10 wherein said structure is natural bark.

18. The apparatus of claim 10 further comprising one or more solar panels.

19. An apparatus comprising:
a water device comprising at least a water-carrying vessel and head in communication with a water source;
a structure including a passageway receiving at least a portion of said water-carrying vessel while leaving said head exposed, said structure configured to blend in with a landscape environment; and
a self-contained music system incorporated in said structure, said self-contained music incorporated including at least a waterproof housing, one or more speakers, interface and port for connection with an external music source.
